(19) United States
(12) Patent Application Publication
(10) Pub. No.: US 2003/0100218 A1
(43) Pub. Date: May 29, 2003

(54) Universal serial bus connector operable so as to indicate signal transmission status

(75) Inventors: Hung-Chang Tsai, Taipei Hsien (TW); Ching-Liang Tu, Taipei Hsien (TW)

Correspondence Address: FOLEY AND LARDNER, SUITE 500, 3000 K STREET NW, WASHINGTON, DC, 20007, US

(73) Assignee: Starlink Electronics Corp.

(21) Appl. No.: 10/096,598

(22) Filed: Mar. 14, 2002

(30) Foreign Application Priority Data
Nov. 26, 2001 (TW) 090220385

(51) Int. Cl. H01R 3/00

(52) U.S. Cl. 439/490

(57) ABSTRACT

A universal serial bus connector includes a main body and at least one indicator. The main body is formed from an insulator material, and has a plug inserting side and a board mounting side. The plug inserting side is formed with at least one plug slot that has a set of conductive contact terminals mounted therein. The contact terminals have solder tails that extend through the board mounting side. The indicator is mounted on the main body, and has power terminals separate from the contact terminals. When the contact terminals and the power terminals are mounted on a circuit board, the indicator can be controlled via the power terminals to indicate the status of signal transmission through the contact terminals.

### BACKGROUND OF THE INVENTION

1. Field of the Invention

The invention relates to a universal serial bus connector, more particularly to one that is operable so as to indicate the signal transmission status.

2. Description of the Related Art

Universal serial bus (USB) connectors are commonly found in computers nowadays. The USB specifications currently available are USB-1.1 and USB-2.0. The signal transmission speed for USB-1.1 is 12 megabits per second, while that for USB-2.0 is 480 megabits per second.

Referring to FIGS. 1 and 2, a conventional USB connector 100 is shown to comprise a main body 11, a metal shield 13 and a plurality of conductive contact terminals 15. The main body 11 is enclosed by the metal shield 13, and is formed with a plug inserting side 12 and a board mounting side 14. The plug inserting side 12 has a pair of plug slots 121. Four of the contact terminals 15 are mounted in each of the plug slots 121. The contact terminals 15 have solder tails that extend through the board mounting side 14. The USB connector 100 is mounted on a circuit board 105 via the solder tails on the board mounting side 14.

However, when a plug connector 101 is plugged into the conventional USB connector 100, there is no indication of the signal transmission status, e.g. whether signal transmission proceeds normally, and the signal transmission speed.

### SUMMARY OF THE INVENTION

Therefore, the object of the present invention is to provide a USB connector that is operable so as to indicate the signal transmission status.

According to the present invention, a universal serial bus connector comprises a main body and at least one indicator.

The main body is formed from an insulator material, and has a plug inserting side and a board mounting side. The plug inserting side is formed with at least one plug slot that has a set of conductive contact terminals mounted therein. The contact terminals have solder tails that extend through the board mounting side.

The indicator is mounted on the main body, and has power terminals separate from the contact terminals.

Thus, when the contact terminals and the power terminals are mounted on a circuit board, the indicator can be controlled via the power terminals to indicate the status of signal transmission through the contact terminals.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional USB connector and a plug connector in an unplugged state;

FIG. 2 illustrates the conventional USB connector and the plug connector of FIG. 1 in a plugged state;

FIG. 3 illustrates the preferred embodiment of a USB connector according to the present invention;

FIG. 4 is a front view of the preferred embodiment;

FIG. 5 is a front view of a modified preferred embodiment of a USB connector according to the present invention;

FIG. 6 is a front view of another modified preferred embodiment of a USB connector according to the present invention;

FIG. 7 is a partly exploded perspective view illustrating a connector module that incorporates the USB connector of this invention;

FIG. 8 illustrates a metal shield of the connector module of FIG. 7; and

FIG. 9 is an assembled perspective view of the connector module of FIG. 7.

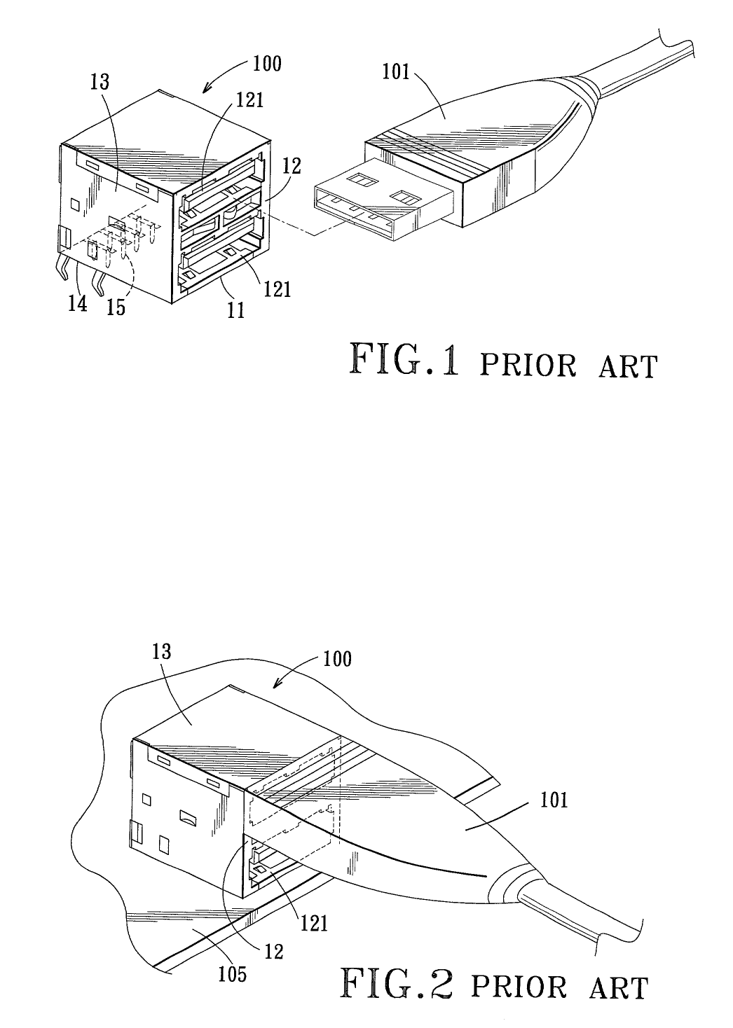

### DETAILED DESCRIPTION OF THE PREFERRED EMBODIMENT

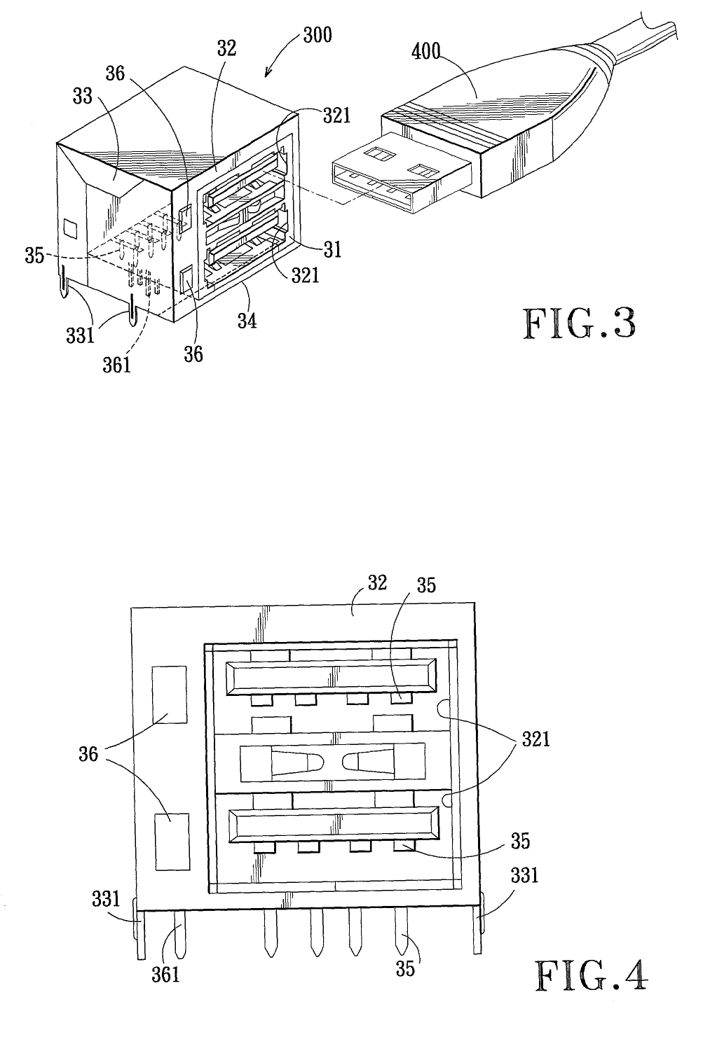

Referring to FIG. 3, the preferred embodiment of a USB connector 300 according to this invention is shown to comprise a main body 31, a metal shield 33, and a plurality of conductive contact terminals 35.

The main body 31, which is formed from an insulator material, is enclosed by the metal shield 33, and has a plug inserting side 32 and a board mounting side 34. The plug inserting side 32 is formed with a pair of plug slots 321. Each of the plug slots 321 has four of the contact terminals 35 mounted therein. The contact terminals 35 have solder tails that extend through the board mounting side 34. Outer ones of the contact terminals 35 in each of the plug slots 321 are used for power transmission, whereas inner ones of the inner contact terminals 35 are used for signal transmission.

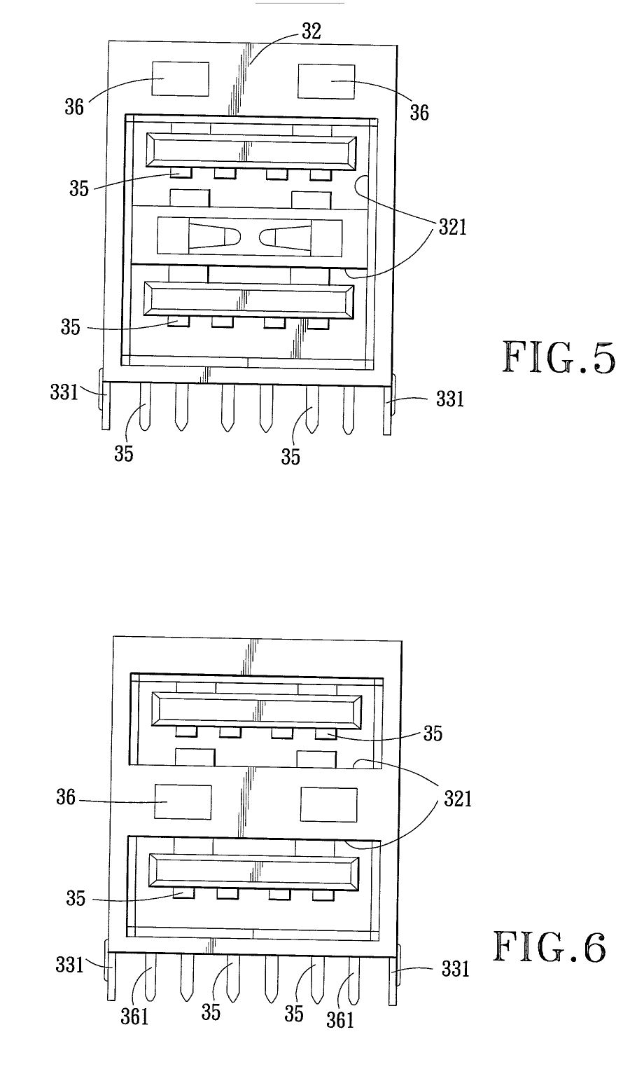

In this embodiment, a pair of indicators 36, such as a light emitting diode, are disposed at the plug inserting side 32 adjacent to the plug slots 321, respectively. Each indicator 36 has a pair of power terminals 361 that extend through the board mounting side 34 of the main body 31. It is noted that the actual position of the indicators 36 on the plug inserting side 32 may be varied. As shown in FIG. 4, the indicators 36 may be provided on the left side of the plug slots 321. As shown in FIG. 5, the indicators 36 may be provided on an upper part of the plug inserting side 32. As shown in FIG. 6, the indicators 36 may be provided between the plug slots 321.

When mounting the USB connector 300 on a circuit board (not shown), insert legs 331 on the metal shield 33 are extended into corresponding holes in the circuit board, and the contact terminals 35 and the power terminals 361 are then soldered to the circuit board for electrical connection therewith.

In use, a plug connector 400 is plugged into one of the plug slots 321 of the USB connector 300. When the connection is good, circuit components on the circuit board will be able to activate the corresponding indicator 36 via the power terminals 361 to generate an appropriate visual indication. Accordingly, in the event of improper connection, the corresponding indicator 36 will remain inactive. The signal transmission speed can be indicated via the indicator 36 by controlling the blinking frequency of the same.

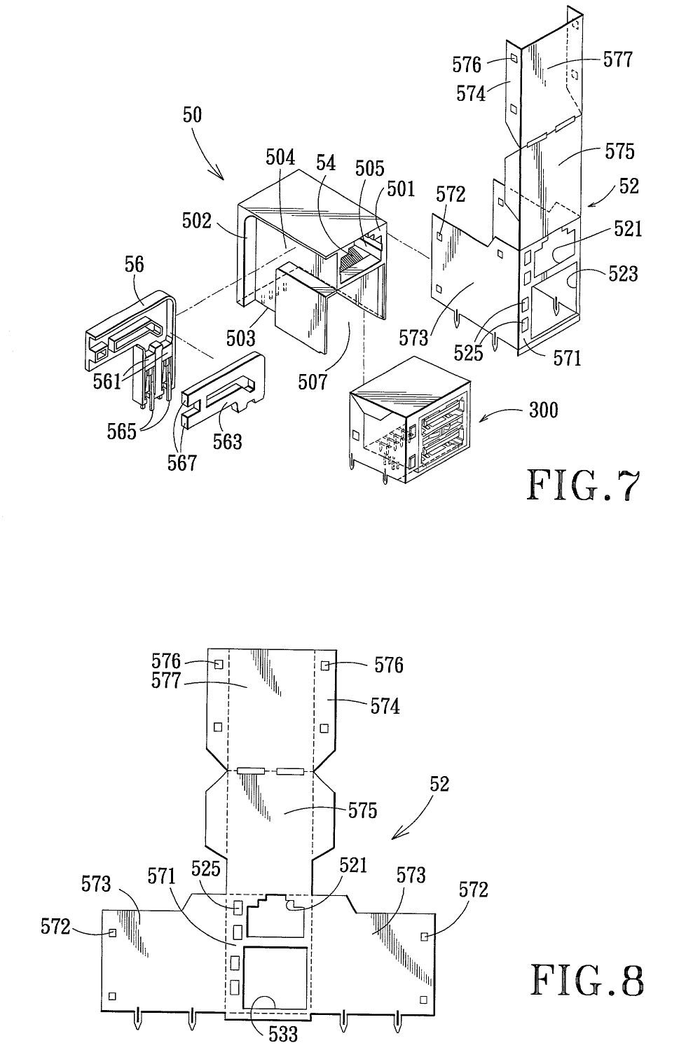

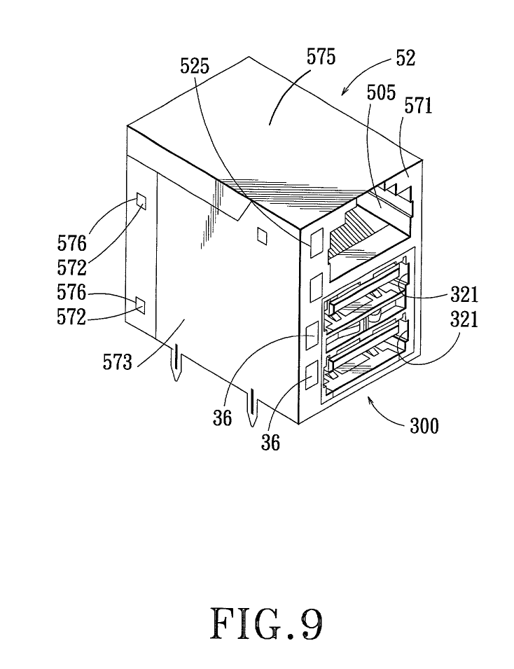

FIGS. 7 to 9 illustrate a connector module that incorporates the USB connector 300. The connector module further includes a second connector, such as a network connector.

The second connector includes a second main body 50, a second metal shield 52 that encloses the second main body 50, and a plurality of conductive second contact terminals 54. The second main body 50 is formed from an insulator material, and has a second plug inserting side 501 and a second board mounting side 503. The second plug inserting side 501 is formed with a second plug slot 505 in which the second contact terminals 54 are mounted. The second contact terminals 54 have second solder tails that extend through the second board mounting side 503. The second main body 50 is further formed with a connector receiving space 507 that opens at the second plug inserting side 501 and the second board mounting side 503. The USB connector 300 is mounted in the connector receiving space 507 such that the plug slots 321 and the indicators 36 of the USB connector 300 are exposed from the second plug inserting side 501 of the second main body 50, and such that the contact terminals 35 of the USB connector 300 extend through the second board mounting side 503 of the second main body 50.

The second main body 50 has a lateral side 502 formed with an L-shaped recess 504 that extends upwardly from the second board mounting side 503 and forwardly to the second plug inserting side 501. An L-shaped frame 56 is fitted in the L-shaped recess 504. A light emitting diode pair 561 is mounted in a bottom end of the L-shaped recess 504. A light guiding member 563 is mounted within the L-shaped frame 56 in the L-shaped recess 503, and has a forked end 567 to be disposed on the second plug inserting side 501 adjacent to the second plug slot 505. As such, light from the diode pair 561 can be directed toward and radiated from the second plug inserting side 501. Due to the presence of the light guiding member 563, the diode pair 561 can be concealed for protecting the same, and the lengths of power terminals 565 of the diode pair 561 can be reduced as well.

When the second contact terminals 54 and the power terminals 565 of the diode pair 561 are mounted on a circuit board (not shown), the diode pair 561 can be controlled via the power terminals 565 to indicate the status of signal transmission through the second contact terminals 54.

Referring to FIG. 8, the second metal shield 52 includes a front plate 571, two lateral plates 573, a top plate 575 and a back plate 577. The lateral plates 573 are connected to two opposite lateral edges of the front plate 571. The top plate 575 is connected to a top edge of the front plate 571. The back plate 577 is connected to a rear edge of the top plate 575. The second metal shield 52 thus encloses five surfaces of the cubic second main body 50, excluding the second board mounting side 503. The front plate 571 is formed with openings 521, 523 that are registered with the second plug slot 505 and the plug slots 321 of the USB connector 300. The front plate 571 is further formed with holes 525 aligned with the forked end 567 of the light guiding member 563 and the indicators 36 of the USB connector 300. Each lateral plate 573 has a rear part formed with a pair of locking tabs 572. The back plate 577 has lateral parts 574 that are formed with a pair of locking holes 576 and that are folded toward a respective one of the lateral plates 573 to engage the locking tabs 572 within the locking holes 574.

Due to the presence of the second metal shield 52, electromagnetic interference shielding of the USB connector 300 can be further enhanced, which is important for high-speed signal transmission applications.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A universal serial bus connector comprising:
a main body formed from an insulator material and having a plug inserting side and a board mounting side, said plug inserting side being formed with at least one plug slot that has a set of conductive contact terminals mounted therein, said contact terminals having solder tails that extend through said board mounting side; and
at least one indicator mounted on said main body and having power terminals separate from said contact terminals;
whereby, when said contact terminals and said power terminals are mounted on a circuit board, said indicator can be controlled via said power terminals to indicate status of signal transmission through said contact terminals.

2. The universal serial bus connector as claimed in claim 1, further comprising a metal shield that encloses said main body.

3. The universal serial bus connector as claimed in claim 1, wherein said indicator is a light indicator.

4. A connector module comprising:
a universal serial bus connector that includes
a first main body formed from an insulator material and having a first plug inserting side and a first board mounting side, said first plug inserting side being formed with at least one first plug slot that has a set of conductive first contact terminals mounted therein, said first contact terminals having first solder tails that extend through said first board mounting side, and
at least one first indicator mounted on said first main body and having first power terminals separate from said first contact terminals; and
a second connector that includes a second main body formed from an insulator material and having a second plug inserting side and a second board mounting side, said second plug inserting side being formed with a second plug slot that has a set of conductive second contact terminals mounted therein, said second contact terminals having second solder tails that extend through said second board mounting side, said second main body being further formed with a connector receiving space that opens at said second plug inserting side and said second board mounting side, said universal serial bus connector being mounted in said connector receiving space;
whereby, when said first contact terminals and said first power terminals are mounted on a circuit board, said first indicator can be controlled via said first power terminals to indicate status of signal transmission through said first contact terminals.

5. The connector module as claimed in claim 4, wherein said universal serial bus connector further includes a first metal shield that encloses said first main body.

6. The connector module as claimed in claim 5, wherein said second connector further includes a second metal shield that encloses said second main body.

7. The connector module as claimed in claim 4, wherein said first indicator is a light indicator.

8. The connector module as claimed in claim 4, wherein said second connector further includes a second indicator mounted on said second main body and having second power terminals separate from said second contact terminals,
whereby, when said second contact terminals and said second power terminals are mounted on the circuit board, said second indicator can be controlled via said second power terminals to indicate status of signal transmission through said second contact terminals.

9. The connector module as claimed in claim 8, wherein said second indicator includes a light emitting diode.

10. The connector module as claimed in claim 9, wherein said second indicator further includes a light guiding member to direct light from said light emitting diode toward said second plug inserting side.

11. The connector module as claimed in claim 10, wherein said second main body has a lateral side formed with an L-shaped recess that extends upwardly from said second board mounting side and forwardly to said second plug inserting side, said light emitting diode being mounted in a bottom end of said L-shaped recess, said light guiding member being mounted in said L-shaped recess and directing the light from said light emitting diode so as to radiate the light at said second plug inserting side.

12. The connector module as claimed in claim 4, wherein said second connector is a network connector.
